(19) United States
(12) Patent Application Publication
(10) Pub. No.: US 2018/0158103 A1
(43) Pub. Date: Jun. 7, 2018

(54) MOBILE BASED COMMON PLATFORM FOR OUTLET SPECIFIC CUSTOMER ENGAGEMENT

(71) Applicant: ITTIAM SYSTEMS PTE. LTD., SINGAPORE (SG)

(72) Inventor: SATTAM DASGUPTA, BANGALORE (IN)

(21) Appl. No.: 15/493,162

(22) Filed: Apr. 21, 2017

Related U.S. Application Data
(63) Continuation-in-part of application No. 15/365,981, filed on Dec. 1, 2016.

(30) Foreign Application Priority Data
Dec. 20, 2016 (IN) 201643043555

(51) Int. Cl. G06Q 30/02; H04L 29/08; H04W 4/02

(52) U.S. Cl. CPC G06Q 30/0259; H04L 67/10; H04L 67/42; H04W 4/02; G06Q 30/0267; H04L 67/306

(57) ABSTRACT

In one example, a method for providing a common platform for outlet-specific customer engagement is described. A plurality of companies, a plurality of outlets corresponding to each of the companies, and users are enabled to subscribe with a cloud-based server. The companies and benefit data associated with each of the companies are provided on a user interface of a mobile device of a user through a client application running on the mobile device. The mobile device is authenticated when the user checks-in through the client application. A location of the mobile device is identified upon authenticating the mobile device. A first outlet of a first company is notified and/or benefit data specific to the first outlet is communicated to the mobile device via the client application when the user is within premises of the first outlet based on the identified location.

### RELATED APPLICATIONS

This application is a Continuation-in-part of patent application Ser. No. 15/365,981 entitled “MOBILE-BASED COMMON PLATFORM ENABLING ELECTRONIC OUTLETS FOR COMPANIES”, filed on Dec. 1, 2016, which claims the benefit under 35 U.S.C. 119(a)-(d) to Indian Application number 201643043555 entitled “MOBILE BASED COMMON PLATFORM FOR OUTLET SPECIFIC CUSTOMER ENGAGEMENT” by ITTIAM SYSTEMS PTE. LTD. Filed on Dec. 20, 2016.

### TECHNICAL FIELD

The present disclosure generally relates to customer engagement, and particularly to mobile based common platform for outlet-specific customer engagement.

### BACKGROUND

Brands/brand outlets may often operate customer loyalty programs to reward selected customers such as customers who frequently shop at retailer's store and/or those customers who spend substantial amounts of money at the retailer's store. Such loyalty programs can offer discounts, customized offers, and the like as rewards to the selected customers based on their previous purchase data. Coupons may be issued by brands or brand outlets (e.g., retailers) to be used in retail stores as a part of sales promotions. They are often widely distributed through mail, magazines, newspapers, Internet, or coupon books directly from the retailer, and mobile devices such as cell phones.

The number of users using mobile devices such as smartphones and tablets is significantly increasing. Also, the amount of time people are spending on these mobile devices to access the Internet is increasing. Thereby, making mobile device an excellent means for businesses to reach out to their consumers. The businesses may communicate information about product or services, offers, feedback and the like through a web browser or a client application residing in the mobile device. Further, mobile applications may enable businesses to track consumers and collect data associated with behavior pattern of the customers through associated client applications. Since the mobile devices are carried by the customers, wherever they go, it is important to take advantage and contextually engage with the customers based on the place they are in.

### BRIEF DESCRIPTION OF THE DRAWINGS

Examples are described in the following detailed description and in reference to the drawings, in which:

FIG. 1A illustrates an example system including a cloud-based server for providing a mobile based common platform for outlet-specific customer engagement;

FIG. 1B illustrates an example block diagram illustrating major components of an outlet-specific customer engagement engine residing in the cloud-based server, such as shown in FIG. 1A;

FIG. 2 illustrates an example process flow between the components of the example system, such as shown in FIG. 1A;

FIGS. 3A and 3B illustrate example user interfaces depicting switchover from brand based customer engagement to brand outlet-specific customer engagement;

FIG. 4 illustrates an example user interface depicting an in-store customer engagement including campaigns specific to an outlet along with generic campaigns of a brand;

FIG. 5 illustrates an example flow chart of a method for providing a mobile based common platform for outlet-specific customer engagement; and

FIG. 6 illustrates a block diagram of an example computing device to provide a mobile based common platform for outlet-specific customer engagement.

### DETAILED DESCRIPTION

Embodiments described herein may provide a system for a plurality of companies/brands to have outlet-specific customer engagement. The system may provide a mobile based common platform for the companies/brands to have the outlet-specific customer engagement. The term “company” refers to a “brand manufacturer” or “business” for selling products or services to customers and provide offers, receive feedback and the like to/from the customers. Each company may be associated with one or more company outlets. Further, the term “company outlet” may refer to a place of business usually owned and operated by a retailer or a manufacturer or its franchises. For example, the company outlet may include a retail store, a supermarket, a grocery store, a shopping mall, a department store, a showroom, a gym, a spa, a restaurant, a hotel and the like associated with the company.

Businesses such as companies (e.g., brands) and company outlets (e.g., brand outlets) may communicate information about products or services, offers, feedback and the like through a client application residing in customer's mobile device. Each business may have its own application and may vie for the customers, resulting in fragmentation of the user base associated with each business. Also, the customers may have to install client applications associated with each of the brands on the mobile device, which consumes significant amount of memory in the mobile device. The number of applications that can be installed on the mobile device may depend on the random-access memory (RAM) and space available, thereby limiting the maximum number of applications that can be installed on the mobile device. Advertisement in other applications may be an option but such advertisements may not provide a dedicated round the clock presence and may not secure the same visibility, engagements and analytics.

Examples described herein may provide a client application running on customers' mobile devices which are communicatively connected with a central cloud-based server having a storage unit. Further, the system includes vendor devices (e.g., mobile device(s), desktop personal computers (PCs) and the like) in the brand outlets and/or in the central office which are connected to the cloud-based server. The vendor devices may have an Internet connection and have an application or browser based application for managing the customer engagement. The client application can be a mobile application or a web-browser based application running on the mobile device.

When a customer is within the premises of an outlet of a brand and checks-in manually or automatically through the client application running on the mobile device, the cloud-based server identifies the customer and directs targeted campaigns specific to the outlet to engage the customer depending on the customer's profile and past engagement pattern. The scope of the campaigns specific to the outlet includes, but not limited to, receiving offers, news of arrival of new items or services, news and communication regarding the brand, enrollment in memberships, availing offers, and managing loyalty programs. Also, the cloud-based server can capture customers' demographic and behavioral details including, but not limited to, a name, address, date of birth, phone number, email address and the like associated with the customers, and details on customer response to the engagement within and across brands and outlets. The captured information may be collected and used to improve quality of marketing, engagement, offerings, and reward or loyalty programs or devise new strategies and the like. In another example, the cloud-based server may include a social networking capability to enable the campaigns of the brand to be shared with other users of the social network and hence can be scaled to a significantly larger audience.

Being a platform and hence a common system for multiple brands, the example cloud-based server described herein may bring customers of many brands together increasing cross-brand-visibility and particularly, reducing fragmentation of the customer base across multiple brand specific engagement solutions (e.g. applications) on the customers' mobile devices. In existing methods, individual brand-specific solutions may have to compete against each other for being retained and used.

Examples described herein may enable automatic or manual check-in of a customer to a specific outlet associated with one of the multiple brands that are subscribed to the cloud-based server. Examples described herein may provide generic or targeted campaign for marketing of products and/or services associated with the brand in general, and the outlet in particular. Examples described herein may provide generic or targeted campaign for engagement (e.g., offers, news of new arrivals, communication in general, and the like) with the customers by the brand in general, and by the outlet in particular. Examples described herein may facilitate enrollment in a membership program of the brand, promotion of offers, news in the customers' social network by the brand or the outlet, programs (e.g., reward or loyalty) across brands, outlets of a brand or multiple brands based on customer engagement patterns. Examples described herein may enable customers to have capabilities to follow or like an outlet, like a campaign from a brand or outlet, promote campaigns within his or her social network, and the like.

The terms “company”, “brand” and “business” are used interchangeably throughout the document and may refer to “manufacturer” or “business” for selling products or services to customers and provide offers, receive feedback and the like to/from the customers. Further, the terms “outlet”, “company outlet” and “brand outlet” are used interchangeably throughout the document and may refer to a physical location of business usually owned and operated by a retailer or a manufacturer or its franchises. Furthermore, the terms “user” and “customer” are used interchangeably throughout the document.

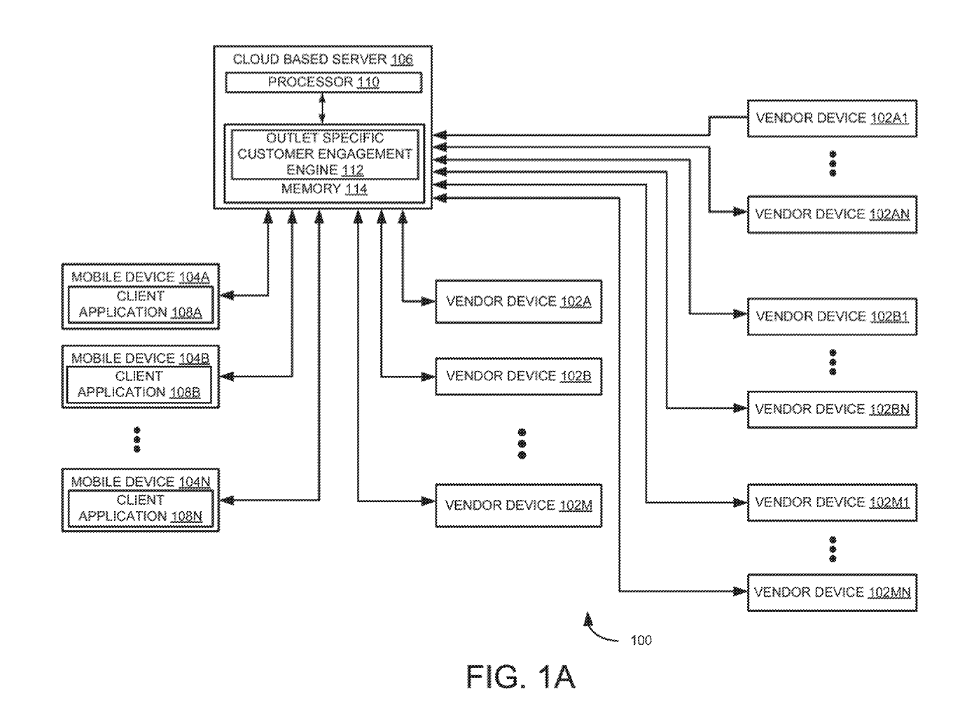

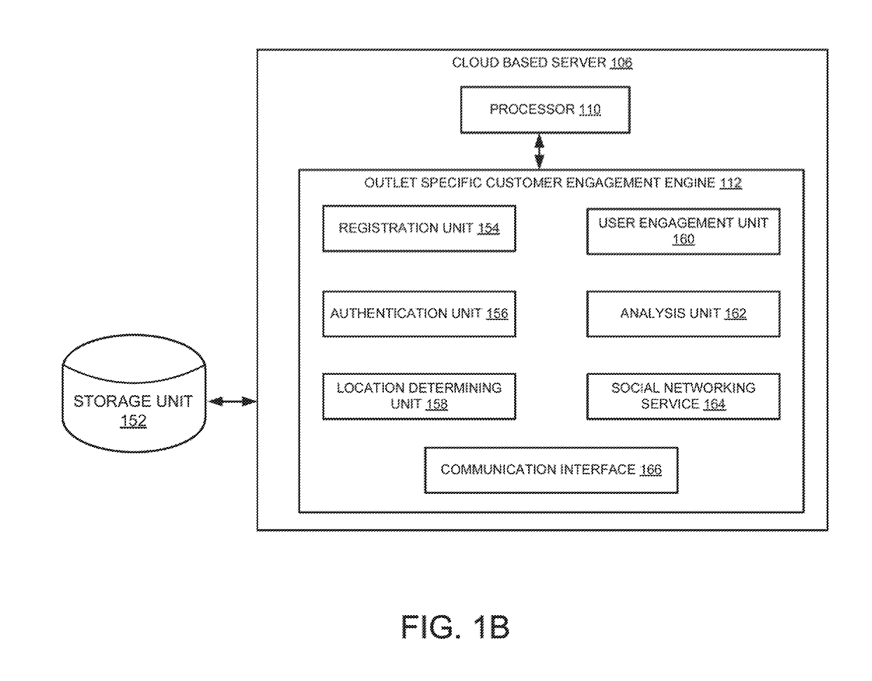

Referring to FIG. 1A, a system 100 may include a plurality of vendor devices (e.g., 102A-M, 102A1-AN, 102B1-BN, and 102M1-MN) associated with a plurality of companies and a plurality of outlets associated with the plurality of companies. In one example, each company may be a brand and each outlet may be a retail store associated with the brand. For example, vendor devices 102A-M may be associated with the companies (e.g., A-M), 102A1-AN may be associated with the outlets associated with the company A, 102B1-BN may be associated with the outlets associated with the company B and the like. For example, the company may be a central office/business and run or operate multiple company outlets at different geographical locations. Example vendor devices may be smart phones, laptops, tablets, PCs, and the like.

Further, the system 100 may include mobile devices 104A-N. The mobile devices 104A-N may run an associated client application 108A-N and may be associated with users. The system 100 may include a cloud-based server 106 communicatively coupled to the plurality of vendor devices (e.g., 102A-M, 102A1-AN, 102B1-BN, and 102M1-MN) and the mobile devices 104A-N over a network, such as wireless network. The client applications 108A-N running on the mobile devices 104A-N are associated with the cloud-based server 106. Example mobile devices 104A-N may be smart phones and/or tablets. For example, mobile devices 104A-N may be configured to include the client application that enables an end-user to log into an end-user account that may be managed by the cloud-based server 106. Such end-user account, for example, may be configured to enable the end-user to receive emails, send/receive IM messages, SMS messages, RSS feeds, to access selected web pages, create and/or publish content, receive compensation, feedback, or the like.

The cloud-based server 106 may include a processor 110, memory 114 coupled to the processor 110, and an outlet-specific customer engagement engine 112 residing in the memory 114. The client application 108A-N may be designed for mobile devices 104A-N in communication with the outlet-specific customer engagement engine 112 to receive benefits and redeem them at the physical location of a company outlet. The outlet-specific customer engagement engine 112 in the cloud-based server 106 may provide a mobile based common platform for outlet-specific customer engagement. The operation/functions associated with the outlet-specific customer engagement engine 112 is explained in FIG. 1B.

FIG. 1B illustrates an example block diagram illustrating major components of the outlet-specific customer engagement engine 112 residing in the cloud-based server 106, such as shown in FIG. 1A. The cloud-based server 106 may be associated with a storage unit 152 to store information related to the users, the companies, the outlets associated with each company, and benefit data specific to the companies and the outlets. Example benefit data specific to the companies and the outlets may be selected from the group consisting of offers, news of arrival of new items or services, news and communication regarding the brand, enrolment in memberships, and loyalty programs. The benefit data specific to the companies and/or outlets may be obtained from respective vendor devices 102 and stored in the storage unit 152 associated with the cloud-based server 106. In one example, the benefit data specific to the outlet (e.g., 102B1) may be obtained from the outlet 102B1 or the company/brand 102B that owns and operates the outlet 10261.

The outlet-specific customer engagement engine 112 may include at least one communication interface 166 receiving instructions from the processor 110 to communicate with the mobile devices 104A-N, the companies (e.g., vendor devices 102A-M), and the outlets (e.g., vendor devices 102A1-AN, 102B1-BN, and 102M1-MN) associated with the companies.

The outlet-specific customer engagement engine 112 may include a registration unit 154 receiving instructions from the processor 110 to enable the plurality of companies, the plurality of outlets, and the users to subscribe with the cloud-based server 106. The storage unit 152 may store information related to the users, the companies, the outlets associated with each company, and benefit data specific to the companies, and the outlets upon subscribing with the cloud-based server 106.

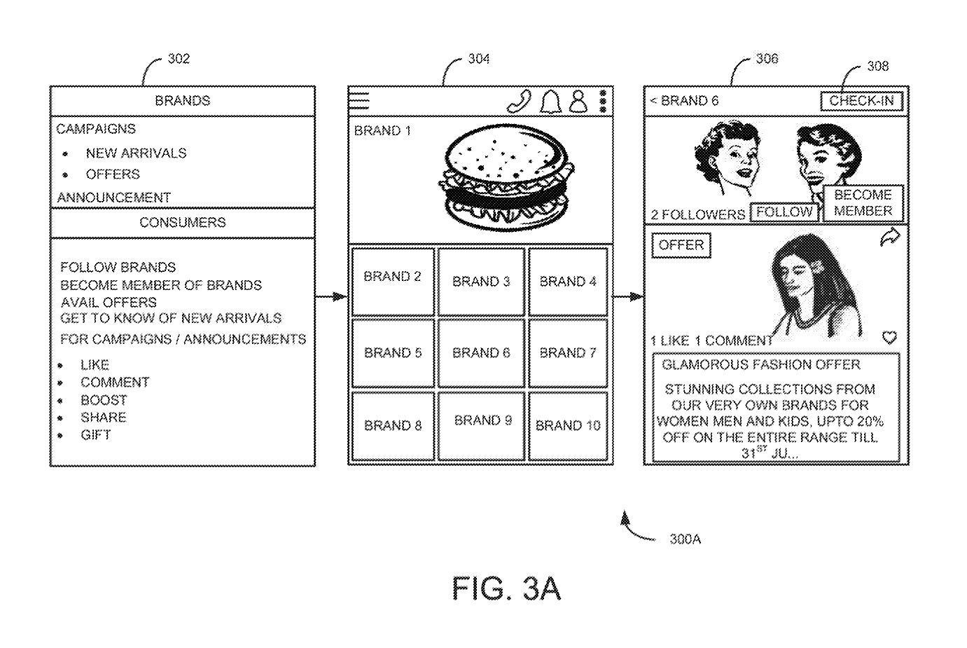

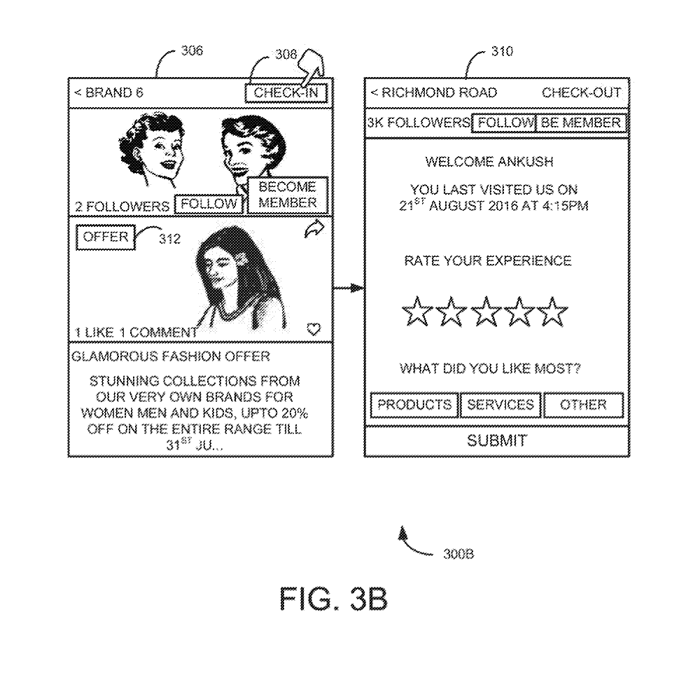

In one example, the communication interface 166 may provide the plurality of companies and the benefit data associated with each of the plurality of companies on a user interface of the mobile device (e.g., 104A) through the client application (e.g., 108A). An example user interface depicting the companies and associated benefit data is shown in FIG. 3A. The client application 108A may be a mobile application or a web-browser based application. The outlet-specific customer engagement engine 112 may include an authentication unit 156 receiving instructions from the processor 110 to authenticate the mobile device 104A when the user is within the premises of a first outlet (e.g., 102B1) of a first company (e.g., 1028) and checks-in through the client application 108A.

The outlet-specific customer engagement engine 112 may include a location determining unit 158 receiving instructions from the processor 110 to identify location of the mobile device 104A via the communication interface 166. The location of the mobile device 104A may be identified based on global positioning system (GPS) technology, Wi-Fi positioning technology, and cellular identification technology. In one example, the location determining unit 158 may identify the location of the mobile device 104A when the user checks-in manually or automatically through the client application 108A.

The outlet-specific customer engagement engine 112 may include a user engagement unit 160 receiving instructions from the processor 110 to notify the first outlet (e.g., 102B1) of the first company (e.g., 102B) when the user is within premises of the first outlet (e.g., 102B1) based on the identified location, and provide benefit data specific to the first outlet (e.g., 102B1) to the mobile device 104A via the client application 108A running on the mobile device 104A.

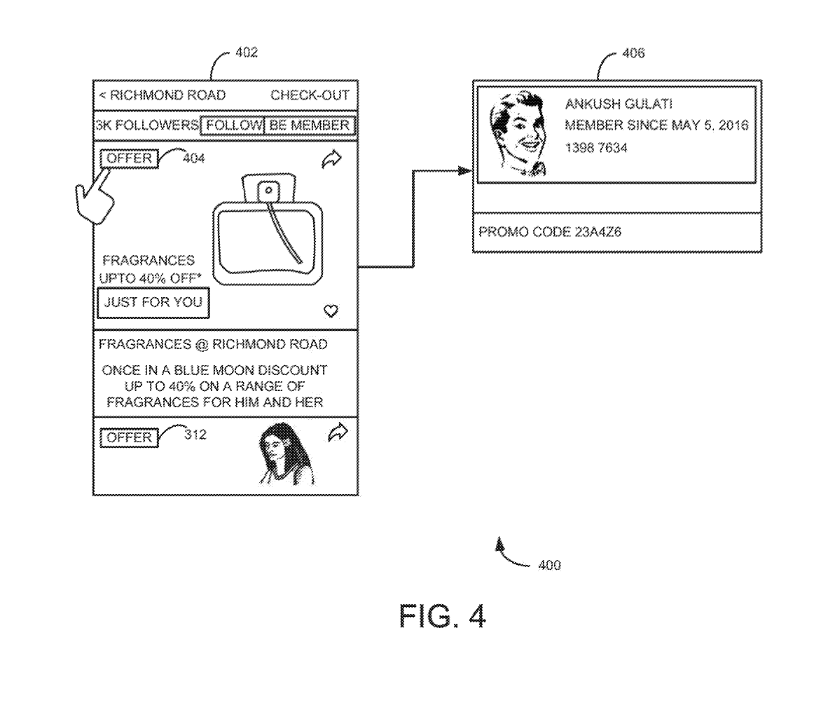

In one example, the communication interface 166 may provide the benefit data specific to the first outlet (e.g., 10261) on a user interface of the mobile device 104A when the user is within premises of first outlet (e.g., 10261) and checks-in through a check-in feature provided on the user interface of the client application 108A, thereby switching over from company based customer engagement to outlet-specific customer engagement. For example, the first company may provide benefits specific to the first outlet during anniversary celebrations, silver jubilee celebrations, and the like of the first outlet. An example user interface depicting the check-in feature is shown in FIG. 3B. An example user interface depicting the benefit data specific to the first outlet is shown in FIG. 4 upon user selecting the check-in feature in the user interface and is within the premises of the first outlet.

In one example, the benefit data specific to the companies and the outlets may be determined based on a user profile and historic usage data associated with the user. The benefit data is determined based on a recommendation by a user engagement unit 160 which matches user profiles with a benefit package stored in the storage unit 152. Further, the benefit data specific to the first outlet may be generated in real-time, for a specific “location” (i.e., such as a store or a shopping mall), in a “personalized way” using personal preferences and may be delivered to a user or a group of users for instant redemption or a later-time redemption.

The outlet-specific customer engagement engine 112 may include an analysis unit 162 receiving instructions from the processor 110 to capture users' demographic and behavioral data within and across the companies and the outlets. For example, the demographic and behavioral data may include information selected from the group consisting of a name, address, date of birth, phone number, and email address of the users, details on user response to engagement within and across the companies and the outlets. Further, the analysis unit 162 may analyze the demographic and behavioral data of the users to improve quality of marketing, engagement, offerings, reward, and/or loyalty programs, or to devise new strategies to the users.

The outlet-specific customer engagement engine 112 may include a social networking service 164 to provide social networking capability to enable the user to share the campaigns of the companies across the users of the social networking service. Further, the user engagement unit 160 may enable the users to rate, like or follow the companies and/or the outlets through the associated client application. For example, user of the mobile device 104A may be allowed to rate, like or follow the first company, the first outlet, and/or benefit data specific to the first company or the first outlet through the client application 108A, for instance, upon availing the benefit data.

In one example, the components of cloud-based server 106 may be implemented in hardware, machine-readable instructions or a combination thereof. In one example, each of the registration unit 154, the authentication unit 156, the location determining unit 158, the user engagement unit 160, the analysis unit 162, the social networking service 164, and the communication interface 166 may be implemented as engines or modules comprising any combination of hardware and programming to implement the functionalities described herein. Even though FIGS. 1A and 1B describe about the cloud-based server 106, the functionality of the components of cloud-based server 106 may be implemented in other electronic devices such as personal computers (PCs), server computers, tablet computers, mobile devices and the like.

The cloud based server 106 may include computer-readable storage medium comprising (e.g., encoded with) instructions executable by the processor 110 to implement functionalities described herein in relation to FIGS. 1A and 1B. In some examples, the functionalities described herein, in relation to instructions to implement functions of the registration unit 154, the authentication unit 156, the location determining unit 158, the user engagement unit 160, the analysis unit 162, the social networking service 164, and the communication interface 166 and any additional instructions described herein in relation to the storage medium, may be implemented as engines or modules comprising any combination of hardware and programming to implement the functionalities of the modules or engines described herein. The functions of components of the outlet-specific customer engagement engine 112 may also be implemented by the processor 110. In examples described herein, the processor may include, for example, one processor or multiple processors included in a single device or distributed across multiple devices.

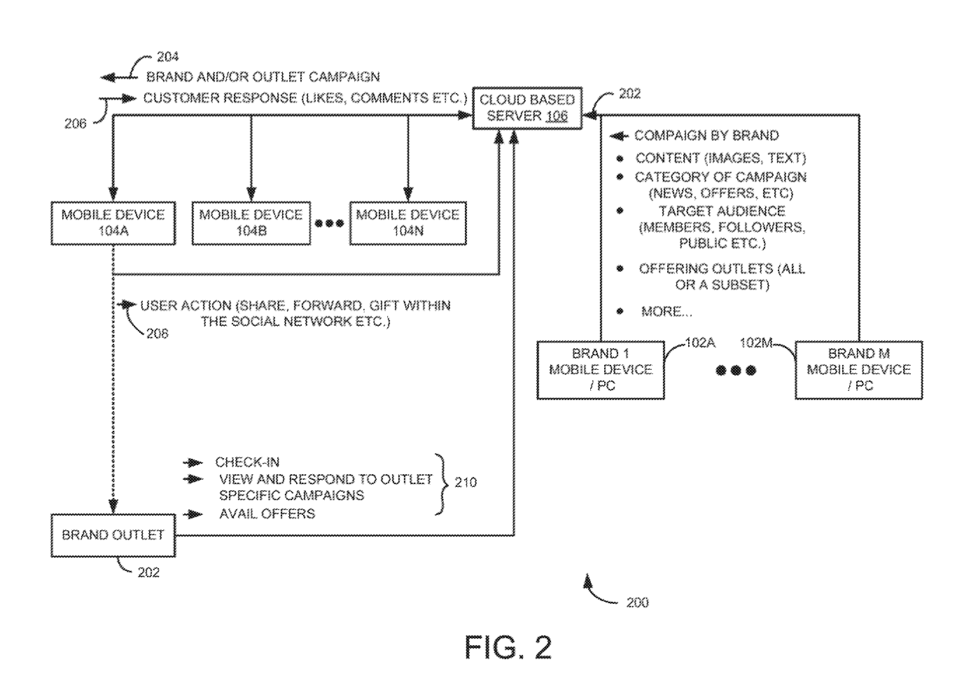

FIG. 2 illustrates an example process flow 200 between the components of the example system 100 such as shown in FIG. 1A. As shown in FIG. 2, upon subscribing with the cloud-based server 106, the brands 1-M having vendor devices 102A-M may send the benefit data specific to the brands and/or outlets for storing in the storage unit 152 associated with the cloud-based server (e.g., at 202). The benefit data may be sent using an installed application or browser based application in the respective vendor devices. For example, benefit data specific to the brands may include campaign by brand such as content (e.g., images, text, and the like), category of campaign (e.g., news, offers, and the like), target users/audience (e.g., members, followers, public and the like), and so on. The benefit data specific to the outlets may include campaign by outlet based on location of the outlets.

Further, the cloud-based server 106 may provide campaigning (e.g., benefit data) based on brands and/or outlets on a user interface of the users' mobile devices 104A-N (e.g., at 204). In one example, the benefit data is determined by matching the user profiles with a benefit package of the brands and/or outlets.

Further, the cloud-based server 106 may capture/receive user responses (e.g., likes, comments, and the like) to the brand and/or outlet campaign (e.g., at 206). Further, the user may be allowed to share, forward, gift the benefit data (e.g., coupon) with the friends in a social network via a social networking service 164 provided by the cloud-based server (e.g., at 208). The shared information may be captured by the cloud-based server 106. The cloud-based server 106 may enable a user to check-in into a brand outlet through a check-in feature provided on the user interface when the user is within the premises of an outlet associated with the brand, to view and respond to campaigns associated with the outlet, and to avail the offers associated with the outlet (e.g., at 210). Further, the cloud-based server 106 may capture the details associated with the user responses to the campaign associated with the outlet and availed offers for further analysis.

FIGS. 3A and 3B illustrate example user interfaces 300A and 300B depicting switchover from brand based customer engagement to brand outlet-specific customer engagement. Particularly, as shown in FIG. 3A, which illustrates example user interfaces 302 depicting campaigns by brand including new arrivals and offers. When a user selects a campaign (e.g., new arrivals or offers), a plurality of brands (e.g., brands 1-10) associated with the selected campaign may be rendered on a user interface 304 of the mobile device. The plurality of brands 1-10 may be associated with the selected campaign. The user interface 300A depicts means for brands to engage with consumers 24/7 anywhere and anytime to provide capabilities such as marketing, visibility, branding, and value added services (e.g., e-membership, membership authentication, offers, and the like).

In one example, when the user selects a particular brand (e.g., brand 6), then the benefit data (e.g., offers) specific to the brand 6 is rendered on a user interface 306 of the mobile device along with other demographic and behavioral data such as followers of the brand 6, likes and comments associated with the offers provided by the brand 6. The user interface 306 may also allow the users to follow, become a member of the brand 6, and the like. Further, the user interface 306 may also provide a check-in feature 308, which when selected by the user, enables user interface to switchover from brand based customer engagement to brand outlet-specific customer engagement as shown in FIG. 3B.

As shown in FIG. 3B, when the user selects the check-in feature 308 associated with the brand 6, campaign data associated with an outlet of the brand 6 may be rendered on a user interface 310 of the mobile device if the user is within the premises of the outlet. The user interface 310 may allow user to follow the outlet, become member of the outlet, rate the experience based on last visit, and the like. The demographic and behavioral data of the users may be collected and analyzed to improve quality of marketing, engagement, offerings, reward, and/or loyalty programs, or to devise new strategies to the users.

The user interface 300A of FIG. 3A may provide brand based customer engagement when the consumer is at home or elsewhere or at a specific store. The user interface 300B of FIG. 3B and 400 of FIG. 4 may provide outlet based customer engagement when the user walks into an outlet/store of the brand. Once a consumer walks into the store of the brand (i.e., on the application platform), the engagement becomes specific to the store. Example, the store can have new arrivals, offers and/or announcements on top of the generic brand campaigns. Thereby, not only does the consumer engages with the overall brand, but also engages with a specific physical store of the brand as soon as the customer walks in to the store.

FIG. 4 illustrates example user interfaces 400 depicting an in-store customer engagement including campaigns specific to the outlet along with generic campaigns of the brand. When user checks-in to the outlet, campaign data associated with the outlet of the brand 6 is rendered on the user interface 402 (e.g., by the cloud-based server 106). In one example, user interface 402 may be rendered upon receiving user's experience rating on the user interface 310. As shown in FIG. 4, the user interface 402 depicts number of followers of the outlet, offers (e.g. general or personalized) associated with the outlet, and the like. For example, as shown in FIG. 4, the outlet at “Richmond road” is offering discount on fragrances over and above the generic brand 6 campaigns. In one example, offer 312 is associated with the generic brand 6 campaign and offer 404 is specific to the outlet (e.g., at Richmond road) of the brand 6. Further, when the user selects the offer 404, a promo code associated with the offer 404 along with membership details may be rendered on the user interface 406.

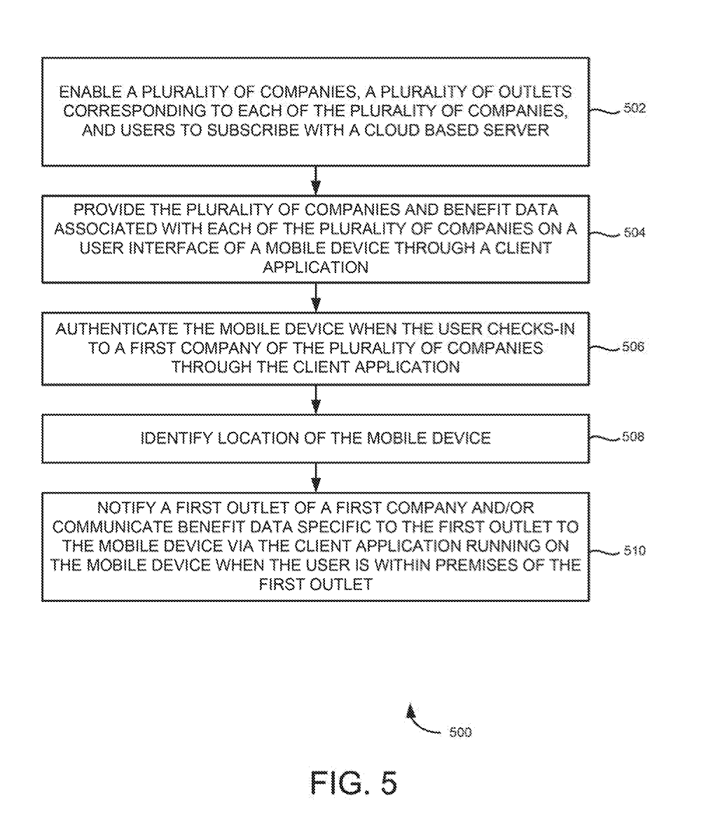

FIG. 5 illustrates an example flow chart 500 of a method for providing a mobile based common platform for outlet-specific customer engagement. It should be understood the process depicted in FIG. 5 represents generalized illustrations, and that other processes may be added or existing processes may be removed, modified, or rearranged without departing from the scope and spirit of the present application. In addition, the processes may represent instructions stored on a computer readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flowcharts illustrate functional information to design or fabricate circuits, generate machine-readable instructions, or use a combination of hardware and machine-readable instructions to perform the illustrated processes.

At 502, a plurality of companies, a plurality of outlets corresponding to each of the plurality of companies, and users may be enabled to subscribe with a cloud-based server. For example, the companies, outlets, and users may be subscribed with a cloud-based server using a mobile based application or a browser based application. Upon subscribing, information related to the users, the companies, the outlets associated with each of the companies, and benefit data specific to the companies and the outlets may be stored in a storage unit associated with the cloud-based server.

At 504, the plurality of companies and benefit data associated with each of the plurality of companies may be provided/rendered on a user interface of a mobile device of a user through a client application running on the mobile device.

At 506, the mobile device is authenticated when the user checks-in through the client application via an authentication unit of the cloud-based server. At 508, location of the mobile device may be identified (e.g., based on GPS, cellular identification or Wi-Fi positional technology) using a location determination unit upon authenticating the mobile device.

At 510, a first outlet of a first company may be notified and/or benefit data specific to the first outlet of the first company may be communicated to the mobile device via the client application running on the mobile device when the user is within premises of the first outlet based on the identified location, thereby switching over from company based customer engagement to the outlet-specific customer engagement. In one example, the benefit data specific to the company and/or the first outlet may be determined based on a user profile and historic usage data associated with the user. For example, the benefit data specific to the first outlet is determined by matching the user profile with a benefit package of the first outlet. The benefit data specific to the first outlet may be obtained from a vendor device associated with the first outlet and/or the first company and stored in a storage unit associated with the cloud-based server. The benefit data specific to the first outlet may be generated and delivered to the mobile device in real-time for instant redemption or a later-time redemption.

Further, users' demographic and behavioral data may be captured within and across the companies and the outlets using an analysis unit of the cloud-based server. Example demographic and behavioral data may include information selected from the group consisting of a name, address, date of birth, phone number, and email address of the users, details on user response to engagement within and across the companies and the outlets. Further, the demographic and behavioral data of the users may be analyzed to improve quality of marketing, engagement, offerings, reward, and/or loyalty programs, or to devise new strategies to the users using the analysis unit.

Furthermore, a social networking capability may be provided to enable campaigns of the companies to be shared/forwarded/gifted across users of a social networking service using the social networking service of the cloud-based server. Further, the user may be allowed to rate, like or follow, the first company or the first outlet, and/or the campaigns associated with first company or the first outlet through the client application.

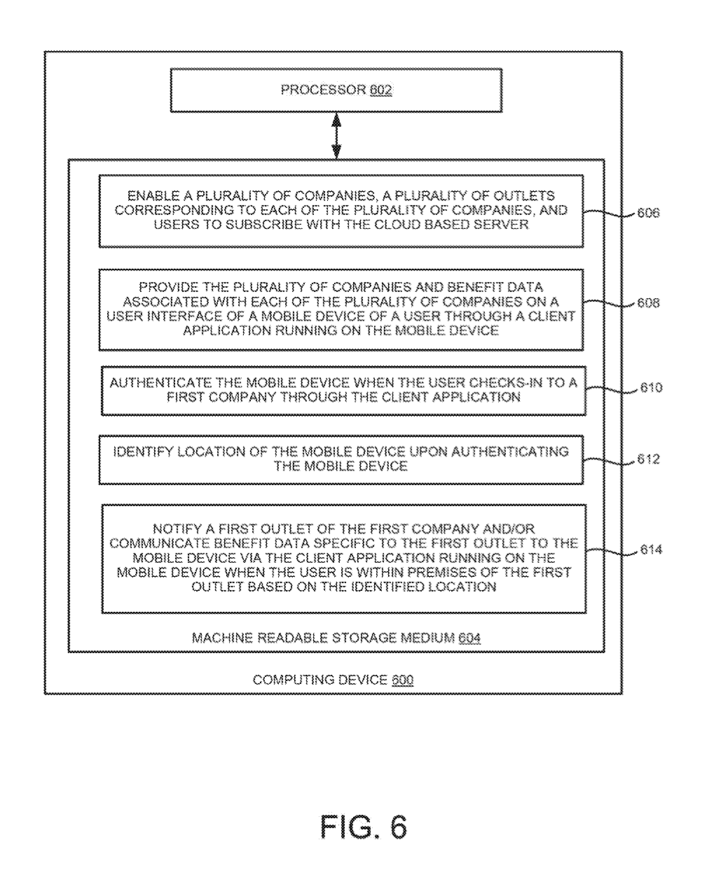

FIG. 6 illustrates a block diagram of an example computing device 600 to provide a mobile based common platform for outlet-specific customer engagement. Example computing device 600 may include a cloud-based server. Computing device 600 may include processor 602 and a machine-readable storage medium/memory 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random-access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing device 600.

Machine-readable storage medium 604 may store instructions 606-614. In an example, instructions 606-614 may be executed by processor 602 to provide a mobile based common platform for outlet-specific customer engagement. Instructions 606 may be executed by processor 602 to enable a plurality of companies, a plurality of outlets corresponding to each of the plurality of companies, and users to subscribe with the cloud-based server. Instructions 608 may be executed by processor 602 to provide the plurality of companies and benefit data associated with each of the plurality of companies on a user interface of a mobile device of a user through a client application running on the mobile device. Instructions 610 may be executed by processor 602 to authenticate the mobile device when the user checks-in through the client application.

Instructions 612 may be executed by processor 602 to identify location of the mobile device upon authenticating the mobile device. Instructions 614 may be executed by processor 602 to perform at least one of notifying a first outlet of the first company and communicating benefit data specific to the first outlet to the mobile device via the client application running on the mobile device when the user is within premises of the first outlet based on the identified location.

Also, although certain terms are used primarily herein, other terms could be used interchangeably to yield equivalent embodiments and examples. For example, the term “device” may be used interchangeably with “physical host”, “physical machine”, “physical device”, or “communication device”. Further for example, the terms “host”, “transmitting device” and “sender” may be used interchangeably throughout the document. Furthermore, the terms “client”, “recipient device”, and “receiver” may be used interchangeably throughout the document. The terms “image”, and “picture” may be used interchangeably throughout the document.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a plurality of vendor devices associated with a plurality of companies and a plurality of outlets associated with the plurality of companies;
at least one mobile device comprising a client application, wherein the at least one mobile device is associated with a user; and
a cloud-based server communicatively coupled to the plurality of vendor devices and the at least one mobile device, wherein the cloud-based service comprises:
a storage unit to store information related to the user, the companies, the outlets associated with each company, and benefit data specific to the companies and the outlets;
a processor;
at least one communication interface receiving instructions from the processor to communicate with the at least one mobile device, the companies, and the outlets associated with each company;
an authentication unit receiving instructions from the processor to authenticate the at least one mobile device when the user checks-in through the client application;
a location determining unit receiving instructions from the processor to identify location of the at least one mobile device via the at least one communication interface; and
a user engagement unit receiving instructions from the processor to notify a first outlet of a first company when the user is within premises of the first outlet based on the identified location, and provide benefit data specific to the first outlet to the at least one mobile device via the client application running on the at least one mobile device.

2. The system of claim 1, wherein the benefit data is determined based on a user profile and historic usage data associated with the user, and wherein the benefit data is determined based on a recommendation by the user engagement unit which matches user profiles with a benefit package of the first outlet.

3. The system of claim 1, comprising a registration unit receiving instructions from the processor to enable the plurality of companies, the plurality of outlets, and the user to subscribe with the cloud-based server.

4. The system of claim 1, wherein each of the plurality of companies comprises a brand, and wherein each of the plurality of outlets comprises a retail store associated with the brands.

5. The system of claim 1, wherein the at least one communication interface to provide the plurality of companies and the benefit data associated with each of the plurality of companies on a user interface of the at least one mobile device through the client application.

6. The system of claim 1, wherein the at least one communication interface to provide the benefit data specific to the first outlet on a user interface of the at least one mobile device when the user is within premises of first outlet and checks-in through a check-in feature provided on the user interface of the client application, thereby switching over from company based customer engagement to outlet-specific customer engagement.

7. The system of claim 1, wherein the location determining unit to identify the location of the at least one mobile device when the user checks-in manually or automatically through the client application.

8. The system of claim 1, wherein the benefit data is selected from the group consisting of offers, news of arrival of new items or services, news and communication regarding the brand, enrolment in memberships, and loyalty programs.

9. The system of claim 1, wherein the cloud-based server comprises:
an analysis unit receiving instructions from the processor to:
capture users' demographic and behavioral data within and across the companies and the outlets, wherein the demographic and behavioral data comprises information selected from the group consisting of a name, address, date of birth, phone number, and email address of the users, details on user response to engagement within and across the companies and the outlets; and
analyze the demographic and behavioral data of the users to improve quality of marketing, engagement, offerings, reward, and/or loyalty programs, or to devise new strategies to the users.

10. The system of claim 1, wherein the cloud-based server comprises:
a social networking service to provide social networking capability to enable campaigns of the companies to be shared across the users of the social networking service by the user.

11. The system of claim 1, wherein the benefit data specific to the first outlet is obtained from a vendor device associated with the first outlet or the first company and stored in the storage unit associated with the cloud-based server.

12. The system of claim 1, wherein the user engagement unit enables the user to rate, like or follow the first company, the first outlet, and/or benefit data specific to the first company or the first outlet through the client application.

13. A cloud-based server comprising:
a storage unit to store information related to users, companies, outlets associated with each company, and benefit data specific to the companies and the outlets;
a processor;
at least one communication interface receiving instructions from the processor to communicate with a mobile device of a user and vendor devices associated with the companies and the outlets;
an authentication unit receiving instructions from the processor to authenticate the mobile device when the user checks-in through a client application running on the mobile device;
a location determining unit receiving instructions from the processor to identify location of the mobile device upon successful authentication via the at least one communication interface; and
a user engagement unit receiving instructions from the processor to notify a first outlet of the first company when the user is within premises of the first outlet based on the identified location, and communicate benefit data specific to the first outlet to the mobile device via the client application running on the mobile device.

14. The cloud-based server of claim 13, wherein the benefit data specific to the first outlet is obtained from a vendor device associated with the first outlet or the first company and stored in the storage unit associated with the cloud-based server.

15. The cloud-based server of claim 13, wherein the benefit data is determined based on a user profile and historic usage data associated with the user, and wherein the benefit data is determined based on a recommendation by the user engagement unit which matches the user profile with a benefit package of the first outlet.

16. The cloud-based server of claim 13, comprising a registration unit receiving instructions from the processor to register the companies, the outlets, and the user with the cloud-based server, wherein each of the companies comprises a brand, and wherein each of the outlets comprises a retail store associated with the brands.

17. The cloud-based server of claim 13, wherein the at least one communication interface to provide the companies and the benefit data associated with each of the companies on a user interface of the mobile device through the client application.

18. The cloud-based server of claim 13, wherein the at least one communication interface to provide the benefit data specific to the first outlet on a user interface of the at least one mobile device when the user is within premises of first outlet and checks-in through a check-in feature provided on the user interface of the client application.

19. The cloud-based server of claim 13, comprises:
an analysis unit receiving instructions from the processor to:
capture users' demographic and behavioral data within and across the companies and the outlets, wherein the demographic and behavioral data comprises information selected from the group consisting of a name, address, date of birth, phone number, and email address of the users, details on user response to engagement within and across the companies and the outlets; and
analyze the demographic and behavioral data of the users to improve quality of marketing, engagement, offerings, reward, loyalty programs, and/or to devise new strategies to the users.

20. The cloud-based server of claim 13, comprises:
a social networking service to provide social networking capability to enable a user to share campaigns of the companies across the users of the social networking service.

21. A method for providing a common platform for outlet-specific customer engagement, comprising:
enabling a plurality of companies, a plurality of outlets corresponding to each of the plurality of companies, and users to subscribe with a cloud-based server;
providing the plurality of companies and benefit data associated with each of the plurality of companies on a user interface of a mobile device of a user through a client application running on the mobile device;
authenticating the mobile device when the user checks-in through the client application via an authentication unit of the cloud-based server;
identifying location of the mobile device using a location determination unit upon authenticating the mobile device; and
performing at least one of notifying a first outlet of a first company and communicating benefit data specific to the first outlet to the mobile device via the client application running on the mobile device when the user is within premises of the first outlet based on the identified location, thereby switching over from company based customer engagement to the outlet-specific customer engagement.

22. The method of claim 21, comprising:
storing information related to the users, the companies, the outlets associated with each of the companies, and benefit data specific to the companies and the outlets in a storage unit associated with the cloud-based server.

23. The method of claim 21, comprising determining the benefit data based on a user profile and historic usage data associated with the user, and wherein the benefit data specific to the first outlet is determined by matching the user profile with a benefit package of the first outlet.

24. The method of claim 21, wherein the benefit data specific to the first outlet is obtained from a vendor device associated with the first outlet or the first company and stored in a storage unit associated with the cloud-based server.

25. The method of claim 21, comprising:
capturing users' demographic and behavioral data within and across the companies and the outlets using an analysis unit of the cloud-based server, wherein the demographic and behavioral data comprises information selected from the group consisting of a name, address, date of birth, phone number, and email address of the users, details on user response to engagement within and across the companies and the outlets; and
analyzing the demographic and behavioral data of the users to improve quality of marketing, engagement, offerings, reward, and/or loyalty programs, or to devise new strategies to the users using the analysis unit.

26. The method of claim 21, comprising:
providing social networking capability to enable campaigns of the companies to be shared across users of a social networking service using the social networking service of the cloud-based server.

27. The method of claim 21, comprising:
enabling the user to rate, like or follow the first company, the first outlet, and/or benefit data specific to the first company or the first outlet through the client application.

28. A non-transitory computer-readable storage medium comprising instructions executable by a cloud-based server to:
enable a plurality of companies, a plurality of outlets corresponding to each of the plurality of companies, and users to subscribe with the cloud-based server;
provide the plurality of companies and benefit data associated with each of the plurality of companies on a user interface of a mobile device of a user through a client application running on the mobile device;
authenticate the mobile device when the user checks-in through the client application;
identify location of the mobile device upon authenticating the mobile device; and
perform at least one of notifying a first outlet of the first company and communicating benefit data specific to the first outlet to the mobile device via the client application running on the mobile device when the user is within premises of the first outlet based on the identified location.

29. The non-transitory computer-readable storage medium of claim 28, comprising determine the benefit data based on a user profile and historic usage data associated with the user, and wherein the benefit data specific to the first outlet is determined by matching the user profile with a benefit package of the first outlet.

30. The non-transitory computer-readable storage medium of claim 28, comprising:
capture users' demographic and behavioral data within and across the companies and the outlets, wherein the demographic and behavioral data comprises information selected from the group consisting of a name, address, date of birth, phone number, and email address of the users, details on user response to engagement within and across the companies and the outlets; and
analyze the demographic and behavioral data of the users to improve quality of marketing, engagement, offerings, reward, and/or loyalty programs, or to devise new strategies to the users.
